(19) United States
(12) Patent Application Publication
(10) Pub. No.: US 2024/0157469 A1
(43) Pub. Date: May 16, 2024

(54) METHOD FOR DETERMINING STABILITY OF WELDING EQUIPMENT, WELDING EQUIPMENT AND DETERMINING DEVICE

(71) Applicant: Fulian Yuzhan Precision Technology Co., Ltd., Shenzhen (CN)

(72) Inventors: YEN TSAN, New Taipei (TW); TSUNG-JU LIN, New Taipei (TW); CHEN-TING WU, New Taipei (TW); MING-TAO LUO, Shenzhen (CN); JUN-MING HUANG, New Taipei (TW); TAI-YU CHOU, New Taipei (TW); QUAN-XI CHEN, Shenzhen (CN)

(21) Appl. No.: 18/507,338

(22) Filed: Nov. 13, 2023

(30) Foreign Application Priority Data
Nov. 10, 2022 (CN) 202211404248.5

(51) Int. Cl. B23K 26/02; B23K 26/70

(52) U.S. Cl. CPC B23K 26/02; B23K 26/707

(57) ABSTRACT

The present application provides a method for determining a stability of a welding equipment. The method includes acquiring initial welding images of the welding equipment; obtaining at least one welding spot position of each of at least one welded workpiece in each initial welding image by processing the initial welding images; determining a welding center position of each welded workpiece based on the at least one welding spot position of each welded workpiece, and obtaining welding center positions of all welded workpieces comprised in the initial welding images; and determining a stability of welding equipment based on the welding center positions of all welded workpieces. The method determines whether the welding equipment is stable by analyzing the welding images, thereby improving an accuracy of a detection of a stability of the welding equipment.

This application claims priority to China Application No. 202211404248.5, having a filing date of Nov. 10, 2022, filed in China State Intellectual Property Administration, the entire contents of which are hereby incorporate by reference.

### FIELD

The present application relates to the field of welding technology, in particular relates to a method for determining a stability of a welding equipment, a welding equipment and a determining device.

### BACKGROUND

Nowadays, a laser welding technology is widely used in a production and a processing of products such as 3C products, automobiles, toys, metal structures, and other products. A layout of welding spots of a structure of a product directly affects a static strength, a static stiffness, a dynamic strength, and a dynamic stiffness of the structure, and a number of the welding spots affects a complexity of a welding process of the structure. Therefore, under a condition of substantially satisfying the static strength, the static stiffness, the dynamic strength, and the dynamic stiffness of the structure, it has a great significance for improving a performance of the structure and reducing a manufacturing cost, by reasonably arranging the layout of the welding spots, reducing the number of the welding spots, and reducing of a failure of the welding spots under load as much as possible.

At present, the layout of the welding spots of the structure is generally designed based on experience, or the layout is obtained by using a pretrained network model. At present, after the welding equipment sets parameters of the layout, the welding equipment welds the structure according to the set parameters. However, after the welding equipment has welded for a long time, foreign matter and impurities may exist on the welding equipment, and the foreign matter and impurities interferes with geometric modules and vibrations of the welding equipment, which leads to errors when the welding equipment performs a laser welding, and results in defects such as misalignment of the welding spots. Therefore, it is necessary to detect a stability of the welding equipment. In some technologies, a welding state is monitored by monitoring a current and arc changes, and the stability of the welding equipment is detected by establishing a mathematical model, this method cannot effectively filter various noises, and an accuracy of determining the stability is low.

### BRIEF DESCRIPTION OF THE DRAWINGS

In order to more clearly illustrate the technical solutions of the embodiments of the present application, the following will briefly introduce the accompanying drawings that need to be used in the embodiments. Obviously, the accompanying drawings in the following description are only some embodiments of the present application. Those of ordinary skill in the art can also obtain other drawings based on these drawings without paying creative labor.

FIG. 1 is a schematic diagram of a flow chart of a method for determining a stability of a welding equipment provided by one embodiment of the present application;

FIG. 2 is a scene schematic diagram of a method for determining the stability of welding equipment provided by one embodiment of the present application;

FIG. 3A is a scene schematic diagram of another method for determining the stability of the welding equipment provided by one embodiment of the present application;

FIG. 3B is a scene schematic diagram of another method for determining the stability of the welding equipment provided by one embodiment of the present application;

FIG. 4A is a schematic diagram of a flow chart of another method for determining the stability of welding equipment provided by one embodiment of the present application;

FIG. 4B illustrates an example of a first workpiece that is normally welded with a second workpiece provided by one embodiment of the present application;

FIG. 4C illustrates an example of the first workpiece that is abnormally welded with the second workpiece provided by one embodiment of the present application;

FIG. 4D illustrates another example of the first workpiece that is abnormally welded with the second workpiece provided by one embodiment of the present application;

FIG. 5A is a scene schematic diagram of another method for determining the stability of the welding equipment provided by one embodiment of the present application;

FIG. 5B is a scene schematic diagram of another method for determining the stability of the welding equipment provided by one embodiment of the present application;

FIG. 5C is a scene schematic diagram of another method for determining the stability of welding equipment provided by one embodiment of the present application;

FIG. 5D is a scene schematic diagram of another method for determining the stability of welding equipment provided by one embodiment of the present application;

FIG. 6 is a scene schematic diagram of another method for determining the stability of welding equipment provided by one embodiment of the present application;

FIG. 7 is a schematic structural diagram of a determining device for the stability of the welding equipment provided by one embodiment of the present application.

### DETAILED DESCRIPTION

In order to better understand the technical solutions of the present application, the embodiments of the present application will be described in detail below in conjunction with the accompanying drawings.

It should be clear that the described embodiments are only some of the embodiments of the present application, not all of the embodiments. Based on the embodiments of this application, all other embodiments obtained by persons of ordinary skill in the art without creative efforts fall within the protection scope of this application.

Terms used in the embodiments of the present application are only for the purpose of describing specific embodiments, and are not intended to limit the present application. The singular forms “a”, “said”, and “the” used in the embodiments of this application and the appended claims are also intended to include plural forms unless the context clearly indicates otherwise.

It should be understood that the term “and/or” used herein is only an association relationship describing associated objects, which means that there may be three relationships, for example, A and/or B, which may mean three situations including that A exists alone, A and B exist simultaneously, and B exists alone. In addition, the character “/” in this article generally indicates that the contextual objects are an “or” relationship.

One embodiment of the present application provides a method for determining a stability of a welding equipment, a device, a welding equipment, and storage medium. The method acquires a plurality of initial welding images of the welding equipment when there is need to detect the stability of the welding equipment, each of the plurality of initial welding images comprising at least one welded workpiece; obtaining at least one welding spot position of each of the at least one welded workpiece by processing the plurality of initial welding images using a detection model. The method further determines a welding center position of each welded workpiece based on the at least one welding spot position of each welded workpiece, and obtains welding center positions of all welded workpieces comprised in the plurality of initial welding images; and determines the stability of the welding equipment based on the welding center positions of all welded workpieces. That is to say, the present application determines whether the welding equipment is stable by analyzing the plurality of initial welding images of the welding equipment after the welding equipment has performed a welding process, thereby improving an accuracy of a detection of the stability of the welding equipment. Moreover, a real-time or regular detection of the stability of the welding equipment can be realized through the above method, which improves a yield rate of products that are welded by the welding equipment. The details will be described below.

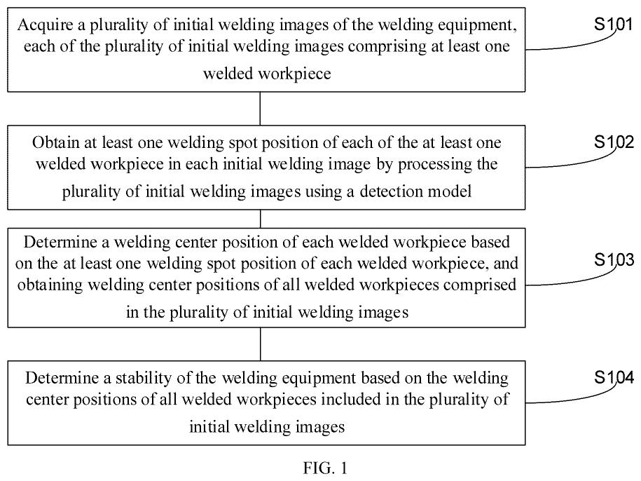

Referring to FIG. 1, it is a schematic diagram of a flowchart of a method for determining the stability of the welding equipment provided by one embodiment of the present application. The method for determining the stability of the welding equipment in the present application can be applied to a determining device. The determining device can be a server, a chip or the welding equipment. As shown in FIG 1, the method includes following steps.

Step S101, acquiring a plurality of initial welding images of the welding equipment.

In one embodiment of the present application, the stability of the welding equipment is determined by performing data analysis on welding images of the welding equipment after the welding equipment performed welding. Therefore, the plurality of initial welding images of the welding equipment needs to be obtained first. In one embodiment, the plurality of initial welding images is obtained by collecting images of welded workpieces welded by the welding equipment using an image acquisition module of the welding equipment. The image acquisition module can be a camera.

Alternatively, the image acquisition module obtains the plurality of initial welding images of the welding equipment by collecting images of the welded workpieces, and stores the plurality of initial welding images in a storage medium or in another equipment. At this time, when the determining device needs to acquire the plurality of initial welding images of the welding equipment, the determining device may acquire the plurality of initial welding images of the welding equipment from the storage medium or the another equipment. It should be understood that each of the plurality of initial welding images includes at least one welded workpiece. That is, each initial welding image includes at least one welded workpiece welded by the welding equipment. In one embodiment, each initial welding image may include more than one welded workpieces. Each welded workpiece may be a workpiece welded to a base material by the welding equipment. Optionally, the workpiece may be a screw, a nut, a flange with a threaded sleeve, etc. The base material can be a metal base material, and the metal base material can be a metal sheet. It should be noted that when one workpiece is welded to a base material, at least one welding spot is formed at a welding position of the workpiece. In one embodiment, an area of the base substrate is more than twice an area of one workpiece.

Step S102, obtaining at least one welding spot position of each of the at least one welded workpiece in each of the plurality of initial welding images by processing the plurality of initial welding images using a detection model.

In one embodiment, each of the at least one welding spot position can be defined to be a position of a welding spot of a welded workpiece. In other words, each workpiece included in each initial welding image has a welding position, and the welding position is formed by the at least one welding spot, and each of the at least one welding spot corresponds to a welding spot position and a welding spot contour. The welding spot contour can be defined to be a contour of the least one welding spot.

In one embodiment, the detection model is a pre-trained model, which is used to extract features of each welded workpiece in each initial welding image, and output each welding spot position of each welded workpiece in each welding image.

In the embodiment of the present application, in order to quickly and accurately determine the at least one welding spot position of each welded workpiece in each welding image, the detection model capable of outputting a welding spot contour of the at least one welding spot of each welded workpiece in each welding image may be pre-trained. In this way, after the determining device acquires the plurality of initial welding images of the welding equipment, the determining device can take the plurality of initial welding images as an input of the detection model and input the plurality of initial welding images into the detection model. The detection model performs feature extraction and splicing of features of each welded workpiece on each of the plurality of initial welding images to obtain the at least one welding spot of each welded workpiece in each initial welding image, and output each welding spot position of each welded workpiece in each initial welding image base on at least one welding spot.

In one implementation, in order to more accurately determine each welding spot position of each welded workpiece in each welding image, after the determining device acquires the plurality of initial welding images, the determining device can input the plurality of initial welding images into the detection model one by one. That is, the determining device can first input one initial welding image to the detection model, and after the detection model outputs each welding spot position of each welded workpiece in the one initial welding image, the determining device can continue to input another initial welding image to the detection model until each welding spot position of each welded workpiece in each initial welding image is obtained.

In one embodiment, each welded workpiece has more than one welding spots, such that there are more than one welding spot positions corresponding to each welded workpiece. Accordingly, the detection model outputs the more than one welding spot positions of each welded workpiece in each initial welding image, and can improve the accuracy of determining the stability of the welding equipment.

In one embodiment, each welding spot position is represented by using coordinates of each welding spot (hereinafter referred to as “welding spot coordinates”). That is, the detection model outputs the welding spot coordinates of each welding spot of each welded workpiece in each initial welding image.

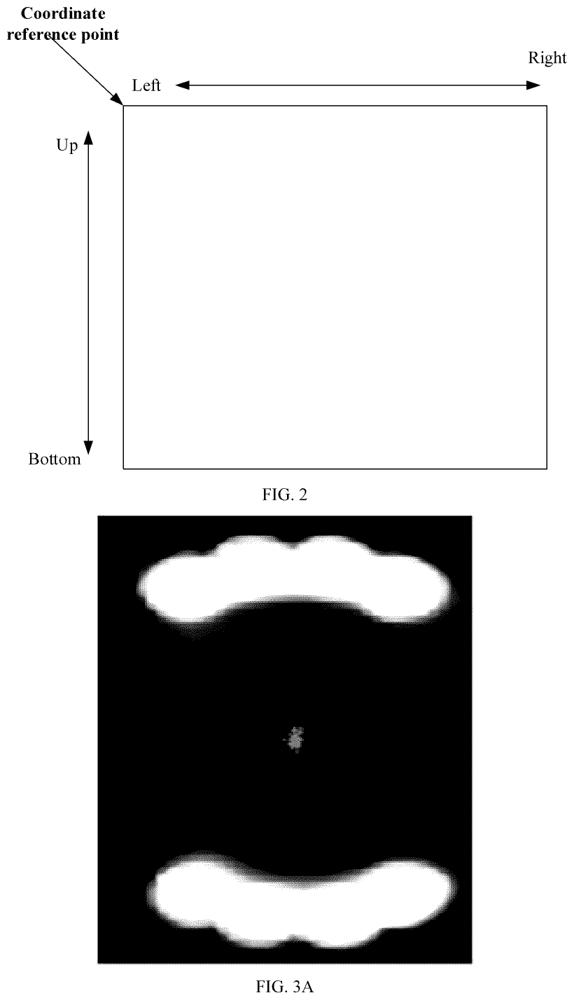

It should be understood that the detection module presets a coordinate reference point, and the welding spot coordinates output by the detection module are coordinates relative to the coordinate reference point. The coordinate reference point may be preset according to actual requirements. For example, as shown in FIG. 2, a position of an upper left corner in the initial welding image may be determined as the coordinate reference point.

In one embodiment, each initial welding image includes at least two welded workpieces. When the determining device inputs each initial welding image including at least two welded workpieces into the detection model, and the detection model performs feature extraction and splicing of features of the at least two welded workpieces on each initial welding images, the detection model can respectively output the welding spot position of each of the at least two welded workpieces in each initial welding image.

In one embodiment, in order to more accurately output each welding spot position of each welded workpiece in each initial welding image, the detection model includes a first detection model and a second detection model, and at the step S102, the obtaining of the at least one welding spot position of each of the at least one welded workpiece in each of the plurality of initial welding images by processing the plurality of initial welding images using the detection model includes:

Step S1021, obtaining a contour of each welded workpiece in each initial welding image by processing each initial welding image using the first detection model, and determining a welding position of each welded workpiece in each initial welding image.

Step S1022, obtaining the at least one welding spot position of each welded workpiece in each initial welding image by processing the welding position of each welded workpiece in each initial welding image using the second detection model.

In one embodiment, in order to accurately determine the at least one welding spot position of each welded workpiece in each initial welding image, the welding position of each welded workpiece in each initial welding image can be determined first, so as to determine the at least one welding spot position of each welded workpiece at the welding position of each welded workpiece. Based on this, the detection model includes the first detection model and the second detection model. The first detection model is a pre-trained model, which is used to process each welded workpiece in each initial welding image, output the contour of each welded workpiece in the initial welding image, and determine the welding position of each welded workpiece in each initial welding image. The second detection model is a pre-trained model, and is used to process the welding position of each welded workpiece, and output the at least one welding spot position of each welded workpiece. In this way, the determining device can obtain the at least one welding spot position of each welded workpiece in each initial welding image through the first detection model and the second detection model. That is to say, after the determining device acquires the plurality of initial welding images of the welding equipment, it can input the plurality of initial welding images into the first detection model, the first detection model performs the recognition of the contour of each welded workpiece in each initial welding image, and obtains the contour of each welded workpiece in each initial welding image, and performs a multi-dimensional feature extraction and a fusion on the contour of each welded workpiece in each initial welding image to obtain the welding position of each welded workpiece in each initial welding image. The second detection module performs a semantic cutting, an extraction of welding features, a fusion and other processing on the welding position of each welded workpiece in each initial welding image to obtain the at least one welding spot position of each welded workpiece.

In one embodiment, the step S1021, the obtaining of the contour of each welded workpiece in each initial welding image by processing each initial welding image using the first detection model, and the determining of the welding position of each welded workpiece in each initial welding image includes:

S10211, the first detection model identifies the contour of each welded workpiece in each initial welding image; S10212, the first detection model takes the contour of each welded workpiece as a reference, and obtains a plurality of images of the contour of each welded workpiece (hereinafter “welded workpiece contour images”) with different sizes from each initial welding image, and each of the plurality of welded workpiece contour images including the contour of each welded workpiece; S10213, for each of the plurality of welded workpiece contour images, the first detection model obtains a plurality of characteristic information of each welded workpiece contour image (hereinafter “welded workpiece contour image characteristic information”) by predicting the welding position of each welded workpiece in each welded workpiece contour image, each of the plurality of welded workpiece contour image characteristic information includes a candidate area of the welding position of each welded workpiece in each welded workpiece contour image and a confidence corresponding to the candidate area; S10214, the first detection model performs a classification processing on each pixel in each initial welding image based on the plurality of welded workpiece contour image characteristic information in each initial welding image, and obtains the welding position of each welded workpiece in each initial welding image, the welding position of each welded workpiece corresponds to the confidence greater than or equal to a preset confidence.

In this embodiment of the present application, the determining device uses the plurality of initial welding images as an input of the first detection model, and inputs them into the first detection model. As an example for convenience of description, since a process of processing each of the plurality of initial welding images by the first detection model is the same, the following uses the first detection model to process one initial welding image as an example for illustration. When the first detection model acquires the initial welding image, it can perform a convolution processing and a pooling processing on the initial welding image, extract multi-layer feature information of the initial welding image, and obtain feature information of each contour in the initial welding image. The first detection model performs a deconvolution processing on the feature information of each contour in the initial welding image to obtain a deconvolution result. A size of the initial welding image becomes smaller after a plurality of pooling operations has been performed on the initial welding image. A deconvolution process increases a size of an image. However, the image after deconvolution processing is only increased in size and cannot restore the original welding image. Therefore, in order to reduce data loss, the convolution result after the previous convolution processing is usually cropped to a corresponding deconvolution image of the same size. The image is directly stitched together to increase the feature information of the image. That is, the deconvolution result and the corresponding convolution result after the convolution process are subjected to feature splicing processing to obtain feature information of each welded workpiece. The feature information of each welded workpiece includes contour information of the welded workpiece in the initial welding image. The first detection model classifies the feature information of each welded workpiece by using a binary classification convolution layer of the first detection model, and outputs an image of the contour of each welded workpiece and a background image. The first detection model identifies the contour of each welded workpiece in the initial welding image. After the first detection model acquires the contour of each welded workpiece, it can use the contour of the welded workpiece as a reference to extract the welded workpiece contour image including the contour of the welded workpiece according to different preset sizes from the initial welding image to form a plurality of welded workpiece contour images with different sizes and each of which is including the contour of the welded workpiece. That is, the first detection model can perform convolution pooling processing on the contour of the welded workpiece according to a preset plurality of convolution pooling kernels, extract the multi-layer feature information of the contour of the welded workpiece, and obtain a plurality of welded workpiece contour images with different sizes and each of which is including the contour of the welded workpiece. The first detection model recognizes and predicts the welding position of the welded workpiece in each welded workpiece contour image, and obtains the feature information of the welded workpiece contour image. The feature information of the welded workpiece contour image includes candidate regions of welding positions in the welded workpiece contour image and corresponding confidences. That is, the first detection model converts the plurality of welded workpiece contour images including the contour of the welded workpiece into description information in the images of the welded workpiece contour images. The first detection model can compare the confidence corresponding to the candidate area of the welding position in each welded workpiece contour image with the preset confidence according to the feature information of each welded workpiece contour image, and determine from each welded workpiece contour image, the candidate area of the welding position whose confidence is greater than or equal to the preset confidence is extracted, and the candidate area of the welding position whose confidence is greater than or equal to the preset confidence is fused in each welded workpiece contour image, so as to obtain the welding position of the welded workpiece in the initial welding image, the welding position can include (x, y, w, h, classification), where “x” represents coordinates in the x direction, “y” represents coordinates in the y direction, “w” represents a width of the welded workpiece, and “h” represents a height of the welded workpiece, “classification” indicates whether there is a classification of welded workpiece.

In one embodiment, the S1022, the obtaining of the at least one welding spot position of each welded workpiece in each initial welding image by processing the welding position of each welded workpiece in each initial welding image using the second detection model includes:

S10221, the second detection model obtains at least one target welding image from each initial welding image, each of the at least one target welding image is obtained by cutting an image corresponding to the welding position of each welded workpiece in each initial welding image.

S10222, the second detection model extracts multi-layer welding feature information from each target welding image, the welding feature information includes a contour image of the at least one welding spot or a contour image of each workpiece in each target welding image.

S10223, the second detection model obtains a plurality of refined feature images by performing an up-sampling and a feature fusion on the multi-layer welding feature information obtained from each target welding image. Each of the plurality of refined feature images obtained from each target welding image includes at least one of the contour image of at least one welding spot, the contour image of each workpiece, and a superposition image of the contour image of at least one welding spot and the contour image of each workpiece in each target welding image.

S1024, for each initial welding image, the second detection model obtains welding information of each welded workpiece by classifying the plurality of refined feature images, and the welding information includes the at least one welding spot position.

In the embodiment of the present application, the welding position includes coordinate positions and size information such as the coordinates of the welded workpiece contour image, the coordinates of the width, and the coordinates of the height. The second detection model performs semantic segmentation on the welded workpiece contour image of the coordinate position and size information to obtain the target welding image. The target welding image is a welding image including a welding position of a welded workpiece. The second detection model performs convolution processing and pooling processing on the target welding image, and extracts the multi-layer welding feature information of the target welding image, such as welding spot feature information, flange contour feature information, sleeve contour feature information, welding spot center feature information, etc., form the welding feature information in the target image. The welding feature information in the target image includes at least one welding spot contour image, or a workpiece contour image in the target welding image. The second detection model performs deconvolution processing on the welding feature information of the target image to form a deconvolution result. Because images of different sizes are obtained after the plurality of pooling processes were performed on the target welding image. For example, the larger the number of convolutions, the smaller the size of the image obtained, and the deconvolution process will increase the size of the image. However, the image after deconvolution processing is only increased in size and cannot restore the target welding image. Therefore, in order to reduce data loss, the convolution result after the previous convolution processing is usually cropped into images of the same size as the corresponding deconvolution, which are directly stitched together to increase the feature information of the images. That is, the deconvolution result and the corresponding convolution result after the convolution process are subjected to feature splicing processing to obtain the plurality of refined feature images. Each of the plurality of refined feature images includes at least one of the at least one welding spot contour image, a workpiece contour image, and a superposition image of the welding spot contour image and the workpiece contour image. The classification convolution layer in the second detection model is used to classify each refined feature image, and the welding information of the welded workpiece is output. The classification convolutional layer can be a layer of classification convolutional layer. At this time, the classification convolutional layer is a welding spot classification convolutional layer, so that the refined feature image can be classified through the classification convolutional layer, and the welding spot in the refined feature image is identified, and the welding information including the welding spot position is obtained. Of course, when the classification convolution layer can also be multi-layered, it can be divided into flange contour classification convolution layer, sleeve contour classification convolution layer, welding spot classification convolution layer, welding gap classification convolution layer, and welding spot center classification convolutional layer. In this way, after the refined feature image is transmitted to the classification convolution layer, the refined feature image is classified through the classification convolution layer to form welding information including different welding features. For example, the welding information includes the at least one welding spot position, a center of the at least one welding spot position, a flange contour, a number of the plurality of welding spots, a welding gap and so on.

In one embodiment, the welding information further includes: an angle of the workpiece, an area of the welding spot, and a number of welding spots in each of the refined feature images.

Step S103, determining a welding center position of each welded workpiece based on the at least one welding spot position of each welded workpiece output by the detection model, and obtaining welding center positions of all welded workpieces included in the plurality of initial welding images.

In the embodiment of the present application, after obtaining the at least one welding spot position of each welded workpiece in each initial welding image, the determining device may calculate a welding center position of each welded workpiece according to the at least one welding spot position of each welded workpiece. For example, when there is only one welding spot position of a welded workpiece, the only one welding spot position may be determined as the welding center position of the welded workpiece. When there are more than one welding spot positions of the welded workpiece, it is necessary to determine the welding center position of the welded workpiece according to the more than one welding spot positions.

In one embodiment, each welded workpiece has a plurality of welding spots, and correspondingly, there are a plurality of welding spot positions of each welded workpiece, and the plurality of welding spot positions are represented using a plurality of welding spot coordinates. In other words, each welded workpiece has a plurality of welding spot coordinates. At this time, at the step S103, the determining of the welding center position of each welded workpiece based on the at least one welding spot position of each welded workpiece output by the detection model includes:

S1031, calculating a welding spot center average value of each welded workpiece based on the plurality of welding spot coordinates of each welded workpiece output by the detection model.

S1032, determining the welding center position of each welded workpiece based on the welding spot center average value of each welded workpiece.

That is, in the embodiment of the present application, generally there are a plurality of welding spots in each welded workpiece, and each welding spot has a corresponding welding spot position (i.e., welding spot coordinate). In order to calculate the welding center position of each welded workpiece more accurately, calculations need to be performed using the plurality of welding spot positions. Since the calculation of the welding spot center average value of each welded workpiece is the same, in this implementation, only the calculation of the welding spot center average value of one welded workpiece is used as an example for illustration. The determining device may calculate an average value of the plurality of welding spot coordinates of one welded workpiece output by the detection model, and take the average value as the welding spot center average value of the one welded workpiece. After calculating the welding spot center average value of each welded workpiece, the determining device may determine the welding center position of each welded workpiece according to the welding spot center average value of each welded workpiece. For example, the welding spot center average value of each welded workpiece can be used as the welding center position of the corresponding welded workpiece. Of course, the welding center position of each welded workpiece can also be determined in other ways, which is not limited in the present application.

For example, the detection model outputs coordinates of three welding spots (i.e., three welding spot coordinates) of a welded workpiece “a” as (x1, y1), (x2, y2), (x3, y3). The determining device can obtain the welding spot center average value of the welded workpiece “a” by calculating an average value of the three welding spot coordinates. At this moment, the welding spot center average value of the welded workpiece “a” is ((x1+x2+x3)/3, (y1+y2+y3)/3). The determining device can determine the welding spot center average value of the welded workpiece “a” as coordinates of a welding center position of the welded workpiece “a”, i.e., the welding center position of the welded workpiece “a” is determined. Similarly, the determining device can calculate the welding spot center average value of a welded workpiece “b” according to a plurality of welding spots coordinates of the welded workpiece “b”, and can determine the welding spot center average value of the welded workpiece “b” as coordinates of a welding center position of the welded workpiece “b”, i.e., the welding center position of the welded workpiece “b” is determined. The determining device can calculate the welding spot center average value of the welded workpiece “c” according to a plurality of welding spots coordinates of the welded workpiece “c”, and can determine the welding spot center average value of the welded workpiece “c” as coordinates of a welding center position of the welded workpiece “c”, i.e., the welding center position of the welded workpiece “c” is determined. The determining device can calculate the welding spot center average value of the welded workpiece “d” according to a plurality of welding spots coordinates of the welded workpiece “d”, and can determine the welding spot center average value of the welded workpiece “d” as coordinates of a welding center position of the welded workpiece “d”, i.e., the welding center position of the welded workpiece “d” is determined.

Step S104, determining a stability of the welding equipment based on the welding center positions of all welded workpieces included in the plurality of initial welding images.

In the embodiment of the present application, after determining the welding center position of each welded workpiece, the determining device can determine the stability of the welding position of each welded workpiece. It should be noted that a stability of a welding position of any one welded workpiece reflects a stability of the welding equipment when the welding equipment welds the any one welded workpiece. When it is determined that the welding position of the each welded workpiece is relatively stable, the welding equipment continues to weld workpieces. Since the welding position of each welded workpiece should be within a qualified range, the determining device can utilize the welding center positions of all welded workpieces to determine the stability of the welding equipment.

In one embodiment, the stability of the welding position of each welded workpiece can be specifically quantified through a variance of the welding spot center of each welded workpiece or a standard deviation of the welding spot center of each welded workpiece. At this time, the S104, the step of determining the stability of the welding position of the welding equipment based on the welding center positions of all welded workpieces includes:

S1041a, calculating the variance of the welding spot center of each welded workpiece and/or the standard deviation of the welding spot center of each welded workpiece based on the plurality of welding spot coordinates of each welded workpiece and the corresponding welding spot center average value of each welded workpiece; S1042a, determining the stability of the welding equipment based on the variance of the welding spot center of each welded workpiece and/or the standard deviation of the welding spot center of each welded workpiece.

As described above, because the stability of the welding position of the welded workpiece reflects the stability of the welding equipment when the welding equipment welds the welded workpiece, therefore, in order to more accurately determine the stability of the welding position of each welded workpiece, the stability of the welding position of each welded workpiece can be determined through the variance of the welding spot center of each welded workpiece or the standard deviation of the welding spot center of each welded workpiece. At this time, for each welded workpiece in each of all the plurality of initial welding images, the determining device may calculate the variance of the welding spot center and/or the standard deviation of the welding spot center of each welded workpiece can be calculated according to the plurality of welding spot coordinates and the welding spot center average value of each welded workpiece. Through the above manner, the determining device can calculate the variance of the welding spot center of each welded workpiece or the standard deviation of the welding spot center of each welded workpiece. The determining device determines the stability of the welding position of each welded workpiece according to the variance of the welding spot center of each welded workpiece or the standard deviation of the welding spot center of each welded workpiece.

The welding position of the welded workpiece further includes the welding spot center of each welded workpiece at least one of the welding spot center average value, the variance of the welding spot center, and the standard deviation of the welding spot center of each of all the welded workpieces. The determining device can determine a concentration situation of the welding positions of all the welded workpieces in the plurality of initial welding images, according to at least one of the welding spot center average value, the variance of the welding spot center, and the standard deviation of the welding spot center of each of all the welded workpieces. The concentration situation includes a first situation of relatively concentrated and a second situation of scattered, if the concentration situation of the welding positions of all the welded workpieces is relatively concentrated, then the determining device can determine that the stability of the welding equipment belongs to a first level; if the concentration situation of the welding positions of all the welded workpieces is scattered, the determining device can determine that the welding positions of all the welded workpieces are scattered, and the stability of the welding equipment belongs to a second level. Each of the first level and the second level can be a value such as a decimal, or a percentage, and the first level is greater than the second level. That is, when the stability of the welding equipment belongs to the first level, the stability of the welding equipment is higher than the stability of the welding equipment when the stability of the welding equipment belongs to the second level.

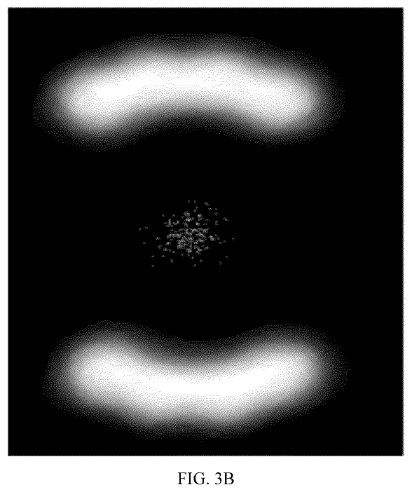

For example, the determining device may obtain a preset center threshold after calculating the welding spot center average value of each welded workpiece. The determining device compares the welding spot center average value of each welded workpiece with the preset center threshold, and if the welding spot center average value of any one welded workpiece is less than the preset center threshold, the determining device can determine that the welding position of the any one welded workpiece belongs the first level, that is, the stability of the welding equipment belongs to the first level. If the welding spot center average value of any one welded workpiece is greater than or equal to the preset center threshold, the determining device can determine that the welding position of the any one welded workpiece belongs to the second level. Through the above method, the determining device can determine whether the welding position each of all welded workpieces in the plurality of initial welding images is stable, and if a first ratio of a first total number of welded workpieces each of which the welding position being stable in the plurality of initial welding images to a second total number of all welded workpieces in the plurality of initial welding images is greater than a preset ratio threshold, the determining device can determine that the concentration situation of the welding positions of all the welded workpieces in the plurality of initial welding images belongs to the first situation, and can determining that the stability of the welding equipment belongs to the first level, as shown in FIG. 3A. Or, if the first ratio is not greater than the preset ratio threshold, the determining device can determine that the concentration situation of the welding positions of all the welded workpieces in the plurality of initial welding images belongs to the second situation, and can determining that the stability of the welding equipment belongs to the second level, as shown in FIG. 3B, the determining device can generate an alarm signal. In another embodiment, the determining device can determine that the concentration situation of the welding positions of all the welded workpieces in the plurality of initial welding images belongs to the first situation and the stability of the welding equipment is high, when a difference between the first total number and the second total number is not greater than a preset difference threshold, as shown in FIG. 3A. Alternatively, if the difference is greater than the preset difference threshold, the determining device can determine that the concentration situation of the welding positions of all the welded workpieces in the plurality of initial welding images belongs to the second situation and the stability of the welding equipment is low, as shown in FIG. 3B, and the determining device can generate an alarm signal at this time.

For another example, the determining device may obtain a preset variance threshold after calculating the variance of the welding spot center of each welded workpiece. The determining device compares the variance of the welding spot center of each welded workpiece with the preset variance threshold, and if the variance of the welding spot center of any one welded workpiece is not greater than the preset variance threshold, the determining device can determine that the welding position of the any one welded workpiece is considered relatively stable, that is, the stability of the welding equipment is considered relatively stable. If the variance of the welding spot center of the any one welded workpiece is greater than the preset variance threshold, the determining device can determine that the welding position of the any one welded workpiece is unstable. Through the above method, the determining device can determine whether the welding position of each of all welded workpieces in the plurality of initial welding images is stable, and if a second ratio of a third total number of welded workpieces each of which the welding position being stable to a fourth total number of all welded workpieces in the plurality of initial welding images is greater than a first preset threshold (the fourth total number is equal to the second total number), the determining device can determine that the welding position of each of all the welded workpieces in the plurality of initial welding images is relatively concentrated, and the stability of the welding equipment is high, as shown in FIG. 3A. Alternatively, if the second ratio is not greater than the first preset threshold, the determining device can determine that the welding position of each of all the welded workpieces in the plurality of initial welding images is scattered and the stability of the welding equipment is low, as shown in FIG. 3B, and the determining device can generate an alarm signal at this time.

Or, in another example, after the determining device calculates the variance of the welding spot center of each welded workpiece, the determining device can detect whether a number of the welding spot center variance that is not greater than the preset variance threshold is greater than a preset number of welded workpieces, and if so, determine the welding position of each welded workpiece is relatively concentrated, and the stability of the welding equipment is high. Otherwise, it is determined that the welding position of each welded workpiece is scattered and the stability of the welding equipment is low. The preset number here may be a number of welding center positions of all welded workpieces in the plurality of initial welding images, or may be 80%-100% of the number of welding center positions of all welded workpieces in the plurality of initial welding images.

It should be noted that, the above examples are illustrated based on the welding spot center average value and the variance of the welding spot center of each welded workpiece have been obtained. In actual implementation, one or more of the welding spot center average value, the standard deviation of the welding spot center and the variance of the welding spot center of each welded workpiece may be obtained. When any two or more of the standard deviation of the welding spot center or the welding spot center average value, the standard deviation of the welding spot center, and the variance of the welding spot center of each welded workpiece, a method for determining the stability of the welding position of each welded workpiece is similar to a method of determining the stability of the welding position of each welded workpiece based on the welding spot center average value and the variance of the welding spot center of each welded workpiece, and can refer to the above method, and will not be repeated here.

In one embodiment, the determining device may also determine the stability of the welding position of each welded workpiece according to whether the welding center position of each welded workpiece is relatively concentrated. At this time, the S104, the step of determining the stability of the welding equipment based on the welding center position of each the welded workpiece includes:

S1041b, determining a total number of welded workpieces whose weld center positions within a standard welding center position range, based on the welding center position of each welded workpiece.

S1042b, determining whether the total number of welded workpieces whose weld center positions within the standard weld center position range meets a preset stable quantity.

S1043b, determining that the stability of the welding equipment is high when the total number of welded workpieces whose weld center positions within the standard weld center position range meets the preset stable quantity.

That is, after the determining device obtains the welding center positions of all welded workpieces in the plurality of initial welding images, for example, the determining device may determine the welding spot center average value of each welded workpiece as the welding center position of each welded workpiece, and the determining device may obtain a preset standard welding center position range. The determining device detects whether the welding center position of each welded workpiece is within the standard welding center position range, so that the total number of welded workpieces whose weld center positions within the standard welding center position range can be counted. The determining device determines whether the total number of welded workpieces whose weld center positions within the standard weld center position range meets the preset stable quantity, the preset stable quantity can be a preset interval range (for example: 550˜600, 600˜650, 1000˜1150, etc.), that is, to detect whether the total number of welded workpieces whose weld center positions within the standard welding center position range is within the preset interval range, if the total number of welded workpieces whose weld center positions within the standard welding center position range is within the preset interval range, it is determined that the stability of the welding position of each welded workpiece is high. The preset stable quantity can also be a preset number value (for example: 550, 600, 1000, etc.), that is, to detect whether the total number of welded workpieces whose weld center positions within the standard welding center position range is greater than the preset number value, if the total number of welded workpieces whose weld center positions within the standard welding center position range is greater than the preset number value, it is determined that the stability of the welding position of each welded workpiece is high, that is, the stability of the welding equipment is high.

For example, the standard welding center position range is (117˜123, 137˜143), that is, a value range of x in the standard welding center position range is 117-123, and a value range of y is 137˜143. After the determining device obtains the welding center position of each welded workpiece, it can detect whether the welding center position of each welded workpiece is within the range of (117˜123, 137˜143). That is, whether the value of x in the welding center position of each welded workpiece is within the range of 117-123, and whether the value of y is within the range of 137-143. If the value of x in the welding center position of the welded workpiece is in the range of 117˜123, and the value of y is in the range of 137˜143, then it is determined that the welding center position of the welded workpiece is within the standard welding center position range, otherwise it is determined that the welding center position of the welded workpiece is not within the standard weld center position range. The determining device can count the total number of welded workpieces whose welding center positions within the standard welding center position range. The determining device compares the total number of welded workpieces whose welding center positions within the standard welding center position range with the preset stable quantity, and if the total number of welded workpieces whose welding center positions within the standard welding center position range is greater than the preset stable quantity, then the determining device determines that the stability of the welding position of each welded workpiece is high, that is, the stability of the welding equipment is high.

It should be understood that the preset stable quantity is a preset threshold used for detecting whether the welding position of each welded workpiece is stable. The preset stable quantity can be a range of numbers, a numerical value, or a ratio. If the preset stable quantity is the numerical value, the numerical value represents a minimum number of the total number of welded workpieces whose welding center positions within the standard welding center position range when the welding position of each welded workpiece is stable. At this time, the preset stable quantity is set according to the total number of welded workpieces whose welding center positions within the standard welding center position range. The preset stable quantity may be a ratio, that is, the ratio between the total number of welded workpieces whose welding center positions within the standard welding center position range and the total number of all welded workpieces. At this time, the preset stable quantity may be a fixed ratio, such as 98%.

In one embodiment, in order to reduce a power consumption of the determining device, when detecting the stability of the welding equipment, a detection may be performed according to initial welding images within a preset time period. At this time, in the above step S101, it is necessary to obtain the plurality of initial welding images of welded workpieces of the welding machine collected continuously within a preset time. The above S1041b, the determining of the total number of welded workpieces whose weld center positions within the standard weld center position range, based on the welding center position of each welded workpiece includes:

S1041b′, within a predetermined time, determining the total number of welded workpieces whose weld center positions are within the standard weld center position range, based on the welding center position of each welded workpiece.

That is, after the determining device acquires the plurality of initial welding images within the predetermined time and determines the welding center position of each welded workpiece in each initial welding image, the determining device can detect the total number of welded workpieces whose welding center positions within the standard weld center position range within the predetermined time. After determining the total number of welded workpieces whose welding center positions within the standard weld center position range within the predetermined time, the determining device can determine whether the total number of welded workpieces whose welding center positions within the standard weld center position range meets the preset stable quantity, and can determines that the stability of the welding position of each welded workpiece is high when the total number of welded workpieces whose welding center positions within the standard weld center position range meets the preset stable quantity.

In one embodiment, when the determining device determines the stability of the welding position of each welded workpiece, it may also determine whether the stability of the welding position of each welded workpiece is medium or low. At this time, the S104, the step of determining the stability of the welding equipment based on the welding center position of each welded workpiece includes:

S1041, determining a total number of welded workpieces whose weld center positions not within the standard weld center position range, based on the welding center position of each welded workpiece within the predetermined time.

S1042, determining whether the total number of welded workpieces whose weld center positions not within the standard weld center position range meets the preset stable quantity.

S1043, determining that the stability of the welding equipment is low or medium when the total number of welded workpieces whose weld center positions not within the standard weld center position range does not meet the preset stable quantity.

S1044, generating a reminder signal when the stability of the welding equipment is low or medium.

That is, after the determining device obtains the welding center positions of all welded workpieces, the determining device can obtain the preset standard welding center position range. The determining device detects whether the welding center position of each welded workpiece is within the standard welding center position range, so that the total number of welded workpieces whose weld center positions are not within the standard welding center position range can be counted. The determining device obtains the preset stable quantity, and detects whether the total number of welded workpieces whose weld center positions not within the standard welding center position range is within the preset stable quantity, that is, detects that whether the total number of welded workpieces whose weld center positions not within the standard welding center position range is greater than or equal to the preset stable quantity, if the total number of welded workpieces whose weld center positions are not within the standard welding center position range is greater than or equal to the preset stable quantity, then it is determined that the stability of the welding equipment is medium or low.

In the embodiment of the present application, the plurality of initial welding images of the welding equipment are obtained, and the at least one welding spot position of each welded workpiece in each welding image is output through the detection model, so that the at least one welding spot center position of each welded workpiece can be determined according to the at least one welding spot position of each welded workpiece, the stability of the welding position of each welded workpiece can be determined according to the welding center position of each welded workpiece, so that the stability of the welding equipment can be determined through the stability of the welding position of each welded workpiece. That is to say, the present application determines whether the welding equipment is stable by analyzing the plurality of welding initial images of the welding equipment, thereby improving the accuracy of the detection of the stability of the welding equipment. And through the above method, a regular inspection of the stability of the welding equipment can be realized, and a yield rate of a product can be improved.

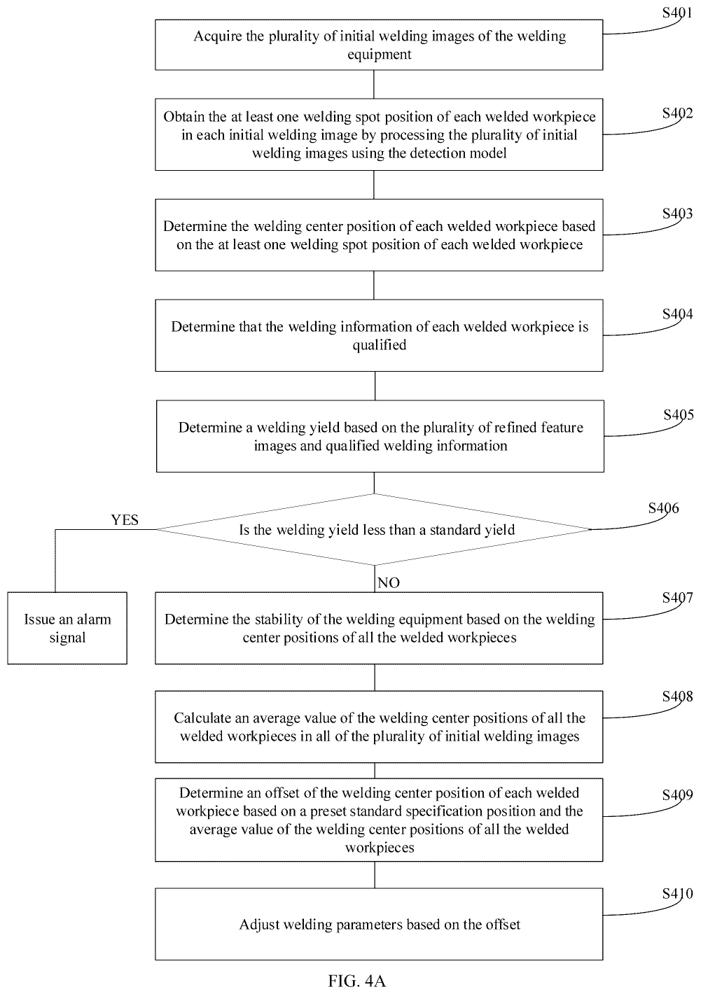

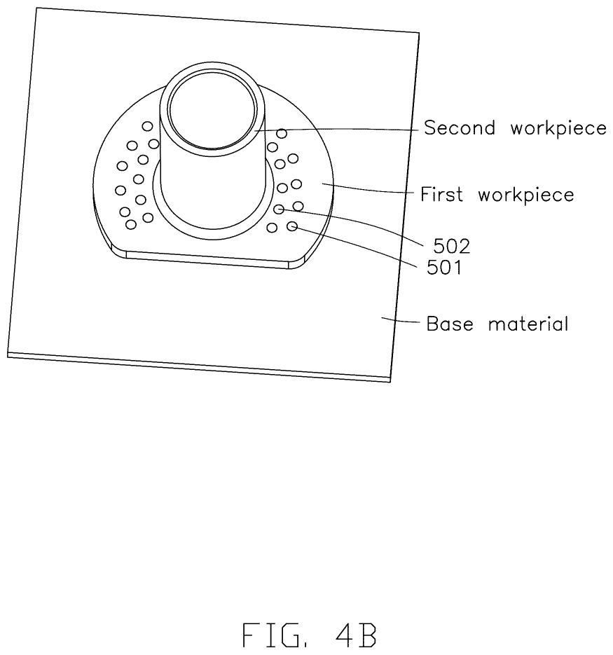

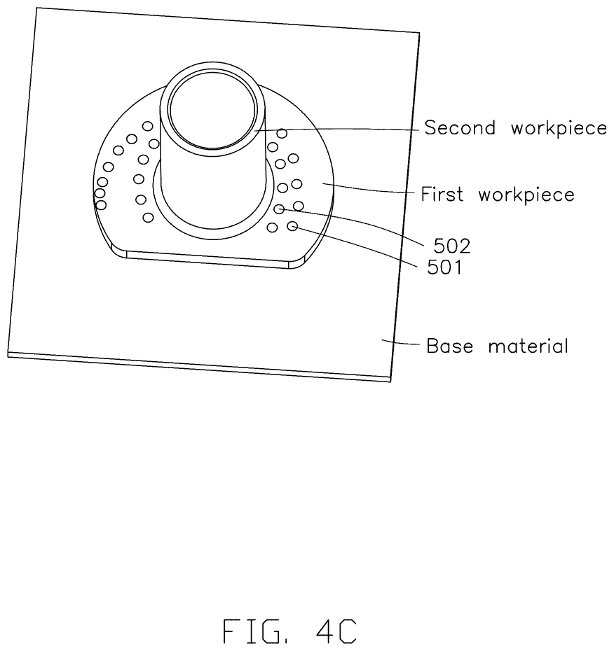

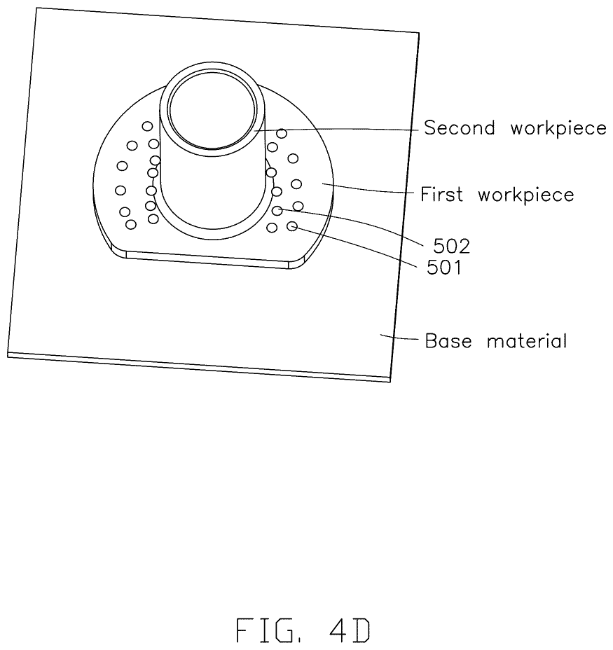

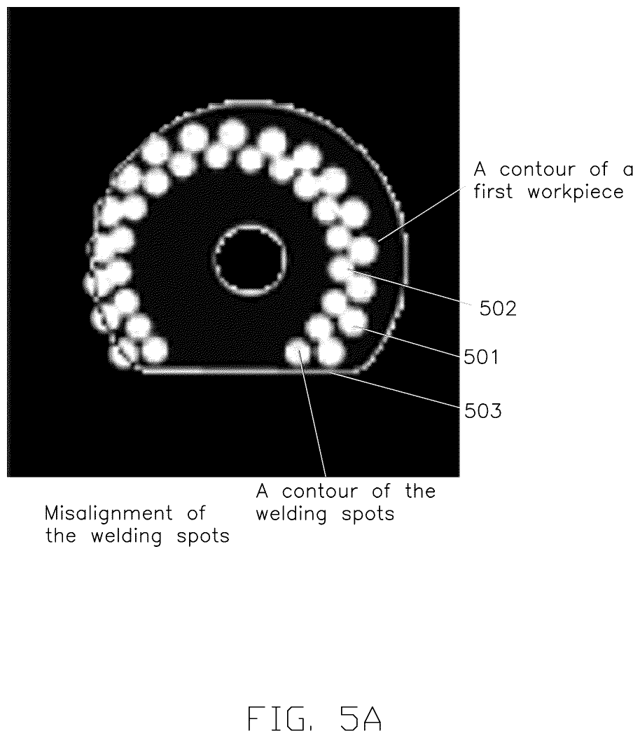

Referring to FIG. 4A, it is a schematic flowchart of a method for determining the stability of welding equipment provided by the embodiment of the present application. Compared with the embodiment described in FIG. 1, the embodiment of the present application adds related steps of obtaining adjustment parameters when the welding equipment is unstable. As shown in FIG. 4A, the method includes:

Step S401, acquiring the plurality of initial welding images of the welding equipment.

For details, refer to step S101, which will not be repeated here.

Step S402, obtaining the at least one welding spot position of each welded workpiece in each initial welding image by processing the plurality of initial welding images using the detection model.

For details, refer to step S102, which will not be repeated here.

Step S403, based on the at least one welding spot position of each welded workpiece output by the detection model, determining the welding center position of each welded workpiece.

For details, refer to step S103, which will not be repeated here.

Step S404, determining that the welding information of each welded workpiece is qualified.

In the embodiment of the present application, in the above step S402, the welding information of each welded workpiece may be output through the detection model. The welding information of each welded workpiece includes the welding spot position, the contour of each welded workpiece, the contour of the at least one welding spot, and the number of welding spots in each of the refined feature images. At this time, the determining device may determine whether there is a welding defect in each welded workpiece according to the welding information of each welded workpiece, that is, determine whether the welding information of each welded workpiece is qualified.

Among them, according to the welding information of each welded workpiece, the determining of whether there is a welding defect in each welded workpiece includes:

When the welding information of each welded workpiece includes the number of welding spots in each refined feature map, determining whether there are defects such as missing soldering, missing workpieces, and few welding spots according to the number of welding spots in each refined feature map; Or, when the welding information of each welded workpiece includes the contour of each welded workpiece and the contour of the at least one welding spot, determining whether there is a defect of welding spot deviation or wall climbing according to the contour of each welded workpiece, the welding position of each welded workpiece, the contour of the at least one welding spot, and the coordinates of the at least one welding spot; or, determining whether there is a defect in a workpiece angle according to the welding position of each welded workpiece.

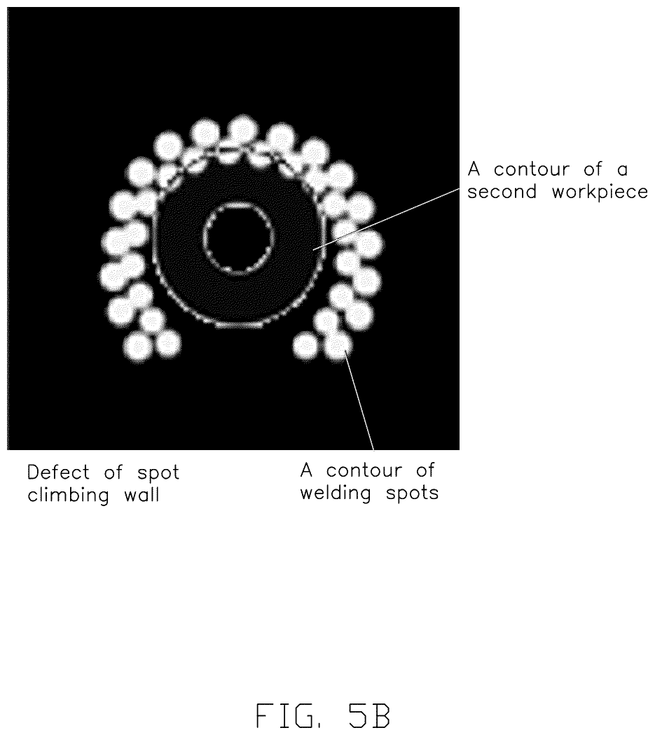

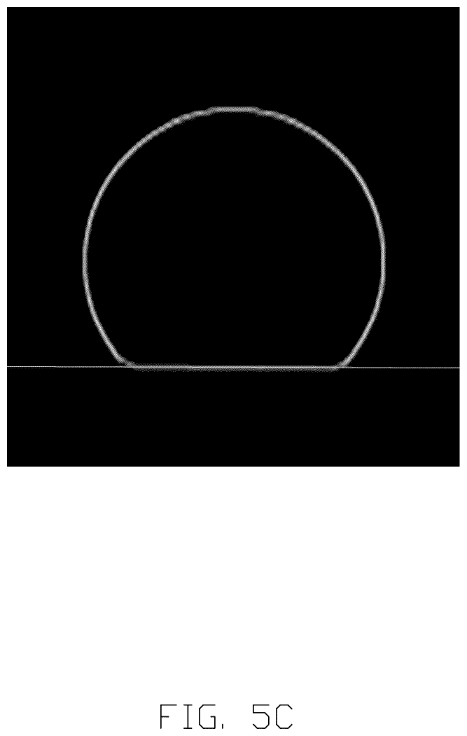

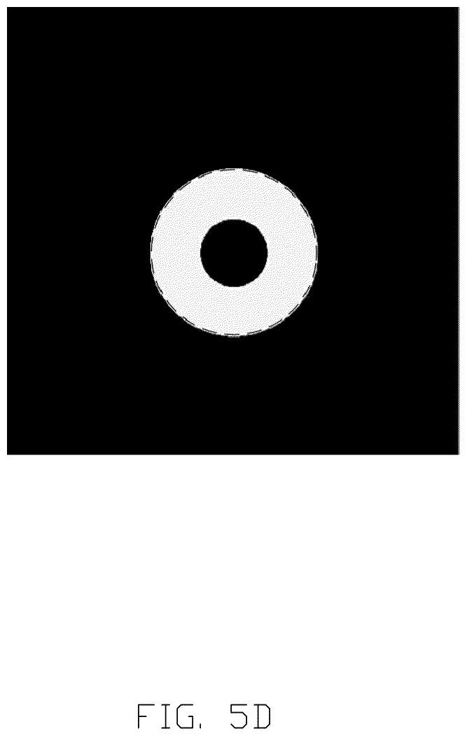

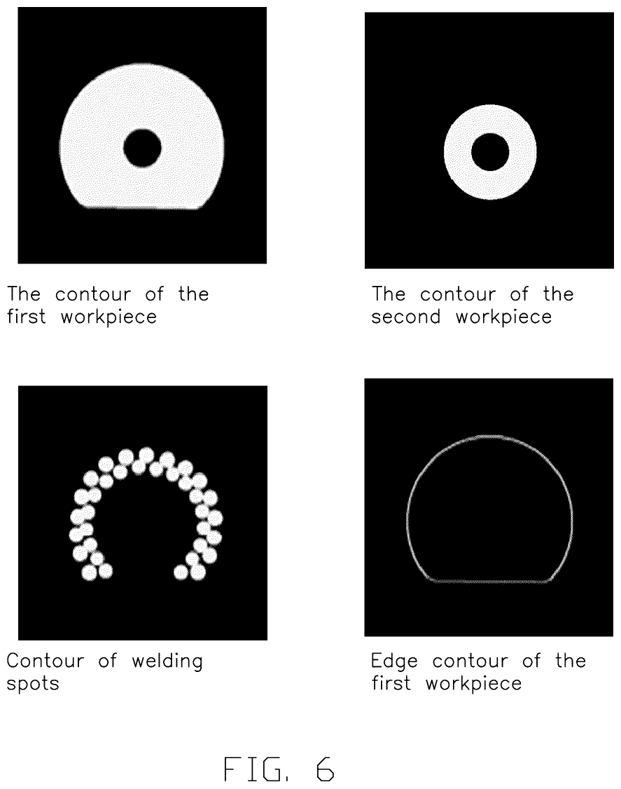

In one embodiment, as shown in FIG. 4B, FIG. 4C, and FIG. 5A, it is assumed that one welded workpiece may include a first workpiece and a second workpiece, the first workpiece may be a flange bottom plate for welding to a metal substrate, the second workpiece may be a sleeve connected to the flange bottom plate, and the sleeve can be a threaded hollow sleeve, such as a nut, and the flange bottom plate can be connected to the metal substrate by welding a circle of welding spots. As shown in FIG. 5A, in another embodiment, in order to improve a welding firmness, the flange bottom plate can be connected to the metal substrate by welding two circles of welding spots. For the convenience of understanding, this embodiment assumes that the flange bottom connected to the metal substrate by welding two circles of welding spots to achieve a connection between the flange bottom and the metal base material, the two circles of welding spots includes a first circle of welding spots 501 and a second circle of welding spots 502 which are welded at intervals between an outer edge contour of the flange bottom plate and an outer edge contour of the sleeve, and the first circle of welding spots 501 is on an periphery of the second circle of welding spots 502. The above-mentioned welding spots include first welding spots and second welding spots. Welding spots in the first circle of welding spots 501 are defined as the first welding spots, and welding spots in the second circle of welding spots 502 are defined as the second welding spots.

In the embodiment of the present application, when the welding information of each welded workpiece includes the number of welding spots, the determining device can detect whether there is a defect of missing welding or a defect of missing workpiece in each welded workpiece by detecting the number of welding spots of each welded workpiece. That is, when the number of welding spots in the welding information obtained by the determining device is zero, it can be determined that there are defects such as missing welding and missing assembly of workpieces. When the number of welding spots is included in the welding information, the determining device may first obtain preset welding parameters. The preset welding parameters include a preset number of welding spots, and the determining device can detect whether the number of welding spots of each welded workpiece is less than the preset number of welding spots, and if the number of welding spots of each welded workpiece is less than the preset number of welding spots, it can determine that there is a defect of missing welding spots.

as shown in FIG. 5A and FIG. 4C, when the welding information includes the contour of the first workpiece and the contour of the at least one first welding spot, the determining device can detect whether the contour of the at least one first welding spot is on or outside the contour of the first workpiece, if the contour of any one of the first welding spots is on or outside the contour of the first workpiece, it is determined that there is a defect of welding spot deviation, as shown in FIG. 5A, the welding spots of the first circle of welding spots on the contour of the first workpiece at a lower left is a defect of welding spot deviation. In one embodiment, welding spot information output by the second detection model is an image. That is, the contour of the first workpiece is an image of the contour of the first workpiece, and the contour of the at least one welding spot is an image of the contour of the at least one welding spot. At this time, the determining device can determine pixel positions of the contour of the first workpiece according to the image of the contour of the first workpiece. According to the image of the contour of the at least one welding spot, the determining device can detect pixel positions of the contour of the at least one welding spot, and then can detect whether the pixel positions of the contour of each welding spot are on or outside the pixel positions of the contour of the first workpiece, if any one of the pixel positions of the contour of any one welding spot is on or outside the pixel positions of the contour of the first workpiece, it can be determined that there is a defect of welding spot deviation. In another embodiment, the determining device can detect whether the contour of the first welding spot deviates from a preset welding circle of the first workpiece, and if the contour of the first welding spot deviates from the preset welding circle, it is determined that there is a welding spot deviation. Specifically, if the contour of the first welding spot deviates from the welding ring of the first workpiece toward the contour of the first workpiece or the direction of the sleeve, it is determined that there is a defect of welding spot offset. Optionally, if more than ⅔ of an area of any one of the first welding spots deviates from the preset welding circle in a direction of the contour of the first workpiece or a direction of the sleeve, it is determined that there is a defect of welding spot deviation. Optionally, if an above-mentioned diameter of the first welding spot deviates from the preset welding circle in the direction of the outline of the first workpiece or the direction of the sleeve, it is determined that there is a defect of welding spot deviation.

As shown in FIG. 4D and FIG. 5B, when the welding information includes the contour of the at least one second welding spot and the contour of the second workpiece, the determining device can detect whether the contour of each second welding spot melts into the contour of the second workpiece, and if the contour of any second welding spot melts into the contour of the second workpiece, it is determined that there is a defect of spot climbing wall. As shown in FIG. 5B, in one embodiment, the welding spot information output by the second detection model is an image. That is, the contour of the second workpiece is an image of the contour of the second workpiece, and the contour of the at least one second welding spot is an image of the contour of the at least one second welding spot. At this time, the determining device can determine the pixel positions of the contour of the second workpiece. According to the image of the contour of each second welding spot, the determining device can detect the pixel positions of the contour of the at least one second welding spot, and then can detect whether the pixel positions of the contour of any second welding spot melt into the pixel positions of the contour of the second workpiece, if at least one of the pixel positions of the contour of any second welding spot melts into the pixel positions of the contour of the second workpiece, it can be determined that there is a defect of welding spot climbing wall.

When the welding information includes the contour of the first workpiece, the determining device can determine the position of the contour of the first workpiece according to the contour of the first workpiece, and then can determine an angle of the first workpiece, and obtain preset welding parameters, the preset welding parameters include an angle threshold of the first workpiece, when the determined angle of the first workpiece exceeds the angle threshold of the first workpiece, it can be determined that there is a defect of the angle of the first workpiece.

In one embodiment, determining the angle of the first workpiece according to the contour of the first workpiece includes: determining a position of the contour of the first workpiece in a first coordinate system according to the contour of the first workpiece; determining the angle of the first workpiece according to the position of the contour of the first workpiece.

That is, when the determining device determines the angle of the first workpiece, it can first determine the position of the contour of the first workpiece in the first coordinate system. For example, when the welding information is image information, the contour of the first workpiece is an image, and the coordinates of each pixel point of an edge contour of the contour of the first workpiece in the image can be determined in the first coordinate system, at this time, the welding information may also include an image of the edge contour of the first workpiece, as shown in FIG. 6. Furthermore, according to a position of the edge contour of the first workpiece in the first coordinate system, a straight line with most points passing the edge contour of the first workpiece in the first coordinate system, such as a straight line 503 in FIG. 5A, can be determined, and an angle at the straight line 503 is determined as the angle of the first workpiece. The determining device can determine the straight line with the most points passing the edge contour of the first workpiece in the first coordinate system according to the position of the contour of the first workpiece in the first coordinate system through the Hough line detection algorithm. At this time, the first coordinate system can be a Cartesian coordinate system, then a straight line in the Cartesian coordinate system corresponds to a point in the Hough space, and a collinear point in the Cartesian coordinate system corresponds to a point in the Hough space Lines intersect. Therefore, according to the position of the contour of the first workpiece in the first coordinate system, the determining device is mapped into the Hough space, so that the most common intersection points of the straight line corresponding to the edge contour of the first workpiece can be determined in the Hough space. That is to determine public intersection points corresponding to the contour of the first workpiece, that is, the straight line that can pass the most points on the edge contour of the first workpiece in the Cartesian coordinate system, as shown in FIG. 5C, and then measure then the angle at the straight line 503 to determine the angle of the first workpiece.

When the welding information includes the contour of the second workpiece, the determining device can determine the position of the contour of the second workpiece according to the contour of the second workpiece, and then can determine whether a shape corresponding to the contour of the second workpiece matches a shape in a preset rule, if the shape corresponding to the contour of the second workpiece does not match the shape in the preset rule, then it can be determined that there is a defect that the second workpiece is deformed.

In one embodiment, detecting whether the contour of the second workpiece conforms to the preset rule includes: determining the position of the contour of the second workpiece in a second coordinate system according to the contour of the second workpiece; determining a shape corresponding to the contour of the second workpiece according to the position of the contour of the second workpiece; judging whether the shape corresponding to the contour of the second workpiece conforms to the preset rule.

The shape corresponding to the contour of the second workpiece may be a circle, and at this time, the preset rule presets the shape corresponding to the contour of the second workpiece is circle. The shape corresponding to the contour of the second workpiece may also be an ellipse, or another shape such as a semicircle, which is not limited in the present application. In this example, the shape corresponding to the contour of the second workpiece may be the circle as an example for illustration. At this time, when the determining device determines the shape of the contour of the second workpiece, it may determine according to the position of each point in the contour of the second workpiece. The determining device may first determine the position of the contour of the second workpiece in the second coordinate system. For example, when the welding information is image information, the contour of the second workpiece is an image, and the coordinates of each pixel point on the edge contour of the second workpiece in the image can be determined in the second coordinate system. Furthermore, according to the position of the edge contour of the second workpiece in the second coordinate system, the determining device can determine the circle that passes the most points on the contour of the second workpiece edge in the second coordinate system, and determine the circle as the circle corresponding to the contour of the second workpiece. The determining device can determine the circle passing the most points on the edge contour of the second workpiece in the second coordinate system according to the position of the contour of the second workpiece in the second coordinate system through the Hough circle detection algorithm. At this time, the second coordinate system can be a Cartesian coordinate system, then a straight line in the Cartesian coordinate system corresponds to a point in the Hough circular space, and a collinear point in the Cartesian coordinate system intersects a corresponding circle in the Hough circular space. Therefore, the position of the edge contour of the second workpiece in the second coordinate system is mapped to the Hough circular space, so that the most common intersection points of the circle corresponding to the edge contour of the second workpiece can be determined in the Hough circular space. That is to determine intersection points of a public circle corresponding to the edge contour of the second workpiece, that is, a circle with the most points passing through the edge contour of the second workpiece in the Cartesian coordinate system can be determined, as shown in FIG. 5D, the circle corresponding to the contour of the second workpiece is determined, so as to determine whether the circle corresponding to the contour of the second workpiece conforms to the preset rule.

It should be noted that if the deformation of the contour of the second workpiece is serious and the determining device cannot detect the circle corresponding to the contour of the second workpiece through the Hough circle detection algorithm, it can be directly determined that the second workpiece has a defect of deformation.

It should be noted that the determining device can preset a range of a size threshold of the shape of the contour of the second workpiece in the preset rule. Taking the shape corresponding to the contour of the second workpiece as a circle as an example, the determining device can preset a range of a size threshold of a standard circle in the preset rule, and determine whether a size of the circle corresponding to the contour of the second workpiece is within the range of the size threshold of the standard circle, if the size of the circle corresponding to the contour of the second workpiece is not within the range of the size threshold of the standard circle, it indicates that the second workpiece of the welded workpiece has a defect of deformation and the welded workpiece is a defective product; if the size of the circle corresponding to the contour of the second workpiece is within the range of the size threshold of the standard circle, then it indicates that the second workpiece of the welded workpiece does not have the defect of deformation, and the welded workpiece is a good product.

Through the above method, the determining device can determine whether each welded workpiece in each initial welding image has a welding defect, so as to determine whether each welding information is qualified according to whether the welding defect is detected in each welding information. When the determining device does not detect the above-mentioned various welding defects according to the welding information, it is determined that the welding information is qualified. If the determining device detects at least one welding defect according to the welding information, it determines that the welding information is unqualified. Through the above manner, the determining device can detect whether each welding information is qualified, and then can determine the quantity of qualified welding information.

Step S405, determining a welding yield based on the plurality of refined feature images and qualified welding information.

In the embodiment of the present application, since the welding information is obtained according to the refined feature map in the second detection model, a quantity of all welding information can be determined according to a number of the plurality of refined feature images, so that the determining device can calculate the welding yield according to the number of qualified welding information and the number of all welding information.

Step S406, determining whether the welding yield is less than a standard yield.

In the embodiment of the present application, the determining device can preset the standard yield rate, and when the yield rate of the welded workpieces welded by the welding equipment exceeds the standard yield rate, it means that the workpieces welded by the welding equipment can be used. At this time, after obtaining the welding yield, the determining device needs to compare the welding yield with the standard yield to determine whether the welding yield is less than the standard yield.

It should be noted that when the welding yield is less than the standard yield, it means that there are many defective welded workpieces welded by the welding equipment. At this time, the determining device can perform an alarm processing to maintain the welding equipment, and no longer perform the following Step S407. When the welding yield is greater than or equal to the standard yield, a welding stability of the welding equipment can be further detected. At this time, continue to execute the following step S407.

Step S407, when the welding yield is greater than or equal to the standard yield, execute step S104 to determine the stability of the welding equipment based on the welding center positions of all the welded workpieces.

For details, reference may be made to the above step S104, which will not be repeated here.

In another embodiment, the method for determining the stability of the welding equipment further includes:

Step S408, calculating an average value of the welding center positions of all the welded workpieces in all of the plurality of initial welding images.

In the embodiment of the present application, when it is determined that the stability of the welding equipment belongs to the second level, adjustment information of the welding equipment may be calculated, so as to adjust the welding equipment accordingly. At this time, the determining device may calculate the average value of the welding center positions of all the welded workpieces in all the initial welding images.

Step S409, determining an offset of the welding center position of each welded workpiece based on a preset standard specification position and the average value of the welding center positions of all the welded workpieces.

In the embodiment of the present application, the determining device can obtain a preset standard specification position, that is, a preset welding position of the welded workpiece, and the determining device calculates the offset between the standard specification position and the average value of the welding center positions of all the welded workpieces, in order to determine the offset of the welded workpiece.

The offset between the standard specification position and the average value of the welding center positions of all the welded workpieces includes a distance offset and/or an angular offset.

In one embodiment, the determining device can use a formula |p₁p₂|=\sqrt{(x₂−x₁)₂+(y₂−y₁)²} to calculate the distance offset between the standard specification position and the average value of the welding center positions of all the welded workpieces. Among them, |p₁p₂| represents the distance offset, p1 is (x₁, y₁) and represents the standard specification position, and p₂ is (x₂, y₂) and represents the welding center position of the welded workpiece.

The determining device can use the formula

$$θ = {tan}^{- 1} \frac{{y}_{2} - {y}_{1}}{{x}_{2} - {x}_{1}}$$

to calculate the angular offset between the standard specification position and the average value of the welding center positions of all the welded workpieces. Among them, θ represents the angular offset.

Step S410, adjusting the welding parameters based on the offset.

In the embodiment of the present application, the determining device can adjust the welding parameters of the welded workpiece according to the calculated offset, for example, it can adjust a placement position of the welded workpiece, the welding position, etc., so as to realize the adjustment of the stability of the welding equipment.

In the embodiment of the present application, the plurality of initial welding images of the welding equipment are obtained, and the welding spot position of each welded workpiece in each welding image is output by the detection model, so that the welding of the corresponding welded workpiece can be determined according to the welding spot position of each welded workpiece, the stability of the welding position of each welded workpiece can be determined according to the welding center position of each welded workpiece, so that the stability of the welding equipment can be determined through the stability of the welding position of each welded workpiece. That is to say, the present application determines whether the welding equipment is stable by analyzing the plurality of initial welding images of the welding equipment after welding, thereby improving the accuracy of the detection of the stability of the welding equipment. And through the above method, the regular inspection of the stability of the welding equipment can be realized, and the yield rate of the product can be improved.

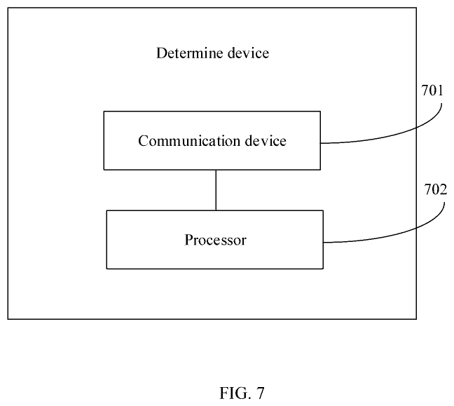

Referring to FIG. 7, it is a schematic structural diagram of a determining device used to determine the stability of the welding equipment provided by an embodiment of the present application. As shown in FIG. 7, the determining device includes:

A communication device 701 acquires the plurality of initial welding images.

A processor 702, coupled to the communication device 701, is used for:

Processing the plurality of initial welding images based on the detection model to obtain the at least one welding spot position of each welded workpiece in each initial welding image output by the detection model;

Determining a welding center position of each welded workpiece based on the at least one welding spot position of each welded workpiece output by the detection model;

Determining the stability of the welding position of each welded workpieces based on the welding center positions of all the welded workpieces.

In one embodiment, each welded workpiece has a plurality of welding spots, correspondingly, each welded workpiece has a plurality of welding spot positions, and the plurality of welding spot positions are represented by a plurality of welding spot coordinates. The processor 702 is specifically configured to: calculate a welding spot center average value of each welded workpiece based on the plurality of welding spot coordinates of each welded workpiece output by the detection model; determine the welding center position of each welded workpiece based on the welding spot center average value of each welded workpiece.

In one embodiment, the processor 702 is specifically configured to, calculate the variance of the welding spot center of each welded workpiece and/or the standard deviation of the welding spot center of each welded workpiece based on the plurality of welding spot coordinates of each welded workpiece and the corresponding welding spot center average value of each welded workpiece; determine the stability of the welding equipment based on the variance of the welding spot center of each welded workpiece and/or the standard deviation of the welding spot center of each welded workpiece.

In one embodiment, the processor 702 is specifically configured to, determine a total number of welded workpieces whose weld center positions within a standard welding center position range, based on the welding center position of each welded workpiece; determine whether the total number of welded workpieces whose weld center positions within the standard weld center position range meets a preset stable quantity; determine the stability of the welding equipment is high when the total number of welded workpieces whose weld center positions within the standard weld center position range meets the preset stable quantity.

In one embodiment, the detection model includes the first detection model and the second detection model. At this time, the processor 702 is specifically configured to, obtain a contour of each welded workpiece in each initial welding image by processing each initial welding image using the first detection model, and determine a welding position of each welded workpiece in each initial welding image; obtain the at least one welding spot position of each welded workpiece in each initial welding image by processing the welding position of each welded workpiece in each initial welding image using the second detection model.

In one embodiment, the processor 702 is specifically used to, obtain a contour of each welded workpiece in each initial welding image by processing each initial welding image using the first detection model; the first detection model identifies the contour of each welded workpiece in each initial welding image; for each initial welding image, the first detection model takes the contour of each welded workpiece as a reference, and obtains a plurality of welded workpiece contour images with different sizes and each of the plurality of welded workpiece contour images including the contour of each welded workpiece; for each of the plurality of welded workpiece contour images, the first detection model obtains a plurality of welded workpiece contour image characteristic information by predicting the welding position of each welded workpiece in each welded workpiece contour image, each of the plurality of welded workpiece contour image characteristic information includes a candidate area of the welding position of each welded workpiece in each welded workpiece contour image and a confidence corresponding to the candidate area; the first detection model performs a classification processing on each pixel in each initial welding image based on the plurality of welded workpiece contour image characteristic information in each initial welding image, and obtains the welding position of each welded workpiece in each initial welding image, the welding position of each welded workpiece corresponds to the confidence greater than or equal to a preset confidence.

In one embodiment, the processor 702 is specifically used to, the second detection model obtains at least one target welding image from each initial welding image, each of the at least one target welding image is obtained by cutting an image corresponding to the welding position of each welded workpiece in each initial welding image through the second detection model; the second detection model extracts multi-layer welding feature information from each target welding image, the welding feature information includes a contour image of the at least one welding spot or a contour image of each workpiece in each target welding image; the second detection model obtains a plurality of refined feature images by performing an up-sampling and a feature fusion on the multi-layer welding feature information obtained from each target welding image. Each of the plurality of refined feature images obtained from each target welding image includes at least one of the contour image of the at least one welding spot, the contour image of each workpiece, and a superposition image of the contour image of the at least one welding spot and the contour image of each workpiece in each target welding image; for each initial welding image, the second detection model obtains welding information of each welded workpiece by classifying the plurality of refined feature images, and the welding information includes the at least one welding spot position.

In one embodiment, the welding information also includes the contour of the workpiece, the contour of the at least one welding spot, the number of welding spots in each refined feature map, and the processor 702 is also used to determine whether the welding information is qualified; determine the welding yield based on the plurality of refined feature images and qualified welding information; determine whether the welding yield is greater than or equal to the standard yield; if not, perform the step “determine the stability of welding equipment based on the welding center position of all welded workpieces”.

In one embodiment, the processor 702 is also configured to, calculate an average value of the welding center positions of all the welded workpieces in all the initial welding images; determine an offset of the welding center position of each welded workpiece based on a preset standard specification position and the average value of the welding center positions of all the welded workpieces; adjust the welding parameters based on the offset.

Corresponding to the above embodiments, the present application also provides the welding equipment, which receives the stability determined by the method for determining the stability of a welding equipment described in the above embodiments, and adjusts welding parameters of the welding equipment based on the stability.

In a specific implementation, the present application also provides a computer storage medium, wherein the computer storage medium can store a program, and when the program is executed, it can include parts or all steps of each embodiment of the method for determining the stability of the welding equipment provided by the present invention. The computer storage medium may be a magnetic disk, an optical disk, a read-only memory (ROM) or a random access memory (RAM), and the like.

Those skilled in the art can clearly understand that the technologies in the embodiments of the present application can be implemented by means of software plus a necessary general-purpose hardware platform. Based on this understanding, the essence of the technical solutions in the embodiments of the present invention or the part that contributes to the prior art can be embodied in the form of software products, and the computer software products can be stored in storage media, such as ROM/RAM, magnetic disk, optical disk, etc., including several instructions to enable a computer device (which may be a personal computer, server, or network device, etc.) to execute the methods described in various embodiments or some parts of the embodiments of the present invention.

For the same and similar parts among the various embodiments in this specification, refer to each other. In particular, for the device embodiment and the terminal embodiment, since they are basically similar to the method embodiment, the description is relatively simple, and for relevant parts, please refer to the description in the method embodiment.

What is claimed is:

1. A method for determining a stability of a welding equipment, comprising:
acquiring a plurality of initial welding images of the welding equipment, each of the plurality of initial welding images comprising at least one welded workpiece;
obtaining at least one welding spot position of each of the at least one welded workpiece by processing the plurality of initial welding images using a detection model;
determining a welding center position of each welded workpiece based on the at least one welding spot position of each welded workpiece output by the detection model; and
determining a stability of the welding equipment based on the welding center positions of all welded workpieces.

2. The method according to claim 1, wherein each of the at least one welded workpiece comprises a plurality of welding spots, and the plurality of welding spots are represented by a plurality of welding spot coordinates, and determining the welding center position of each welded workpiece based on the at least one welding spot position of each welded workpiece comprises:
calculating a welding spot center average value of each welded workpiece, based on the plurality of welding spot coordinates of each welded workpiece; and
determining the welding center position of each welded workpiece based on the welding spot center average value of each welded workpiece.

3. The method according to claim 2, wherein determining the stability of the welding equipment based on the welding center positions of all welded workpieces comprises:
calculating a variance of the welding spot center of each welded workpiece and/or a standard deviation of the welding spot center of each welded workpiece based on the plurality of welding spot coordinates of each welded workpiece and a corresponding welding spot center average value of each welded workpiece;
determining the stability of the welding equipment based on the variance of the welding spot center of each welded workpiece and/or the standard deviation of the welding spot center of each welded workpiece.

4. The method according to claim 1, wherein determining the stability of the welding equipment based on the welding center positions of all welded workpieces comprises:
determining a total number of welded workpieces whose welding center positions within a standard welding center position range, based on the welding center position of each welded workpiece;
determining whether the total number of welded workpieces whose welding center positions within the standard welding center position range meets a preset stable quantity; and
determining that the stability of the welding equipment is high in response that the total number of welded workpieces whose weld center positions within the standard weld center position range meets the preset stable quantity.

5. The method according to claim 1, wherein the detection model comprises a first detection model and a second detection model, wherein obtaining the at least one welding spot position of each welded workpiece by processing the plurality of initial welding images using the detection model comprises:
obtaining a contour of each welded workpiece in each initial welding image by processing each initial welding image using the first detection model, and determining a welding position of each welded workpiece in each initial welding image; and
obtaining the at least one welding spot position of each welded workpiece in each initial welding image by processing the welding position of each welded workpiece in each initial welding image using the second detection model.

6. The method according to claim 5, wherein obtaining the contour of each welded workpiece in each initial welding image by processing each initial welding image using the first detection model, and determining the welding position of each welded workpiece in each initial welding image comprises:
identifying the contour of each welded workpiece in each initial welding image by processing each initial welding image using the first detection model;
extracting the contour of each welded workpiece as a reference, and obtaining a plurality of welded workpiece contour images with different sizes from each initial welding image using the first detection model, each of the plurality of welded workpiece contour images comprises the contour of each welded workpiece;
obtaining a plurality of welded workpiece contour image characteristic information by predicting the welding position of each welded workpiece in each welded workpiece contour image using the first detection model, each of the plurality of welded workpiece contour image characteristic information comprises a candidate area of the welding position of each welded workpiece in each welded workpiece contour image and a confidence corresponding to the candidate area; and
performing a classification processing on each pixel in each initial welding image based on the plurality of welded workpiece contour image characteristic information in each initial welding image, and obtaining the welding position of each welded workpiece in each initial welding image using the first detection model, the welding position of each welded workpiece corresponding to the confidence being equal to or greater than a preset confidence.

7. The method according to claim 6, wherein obtaining the at least one welding spot position of each welded workpiece in each initial welding image by processing the welding position of each welded workpiece in each initial welding image using the second detection model comprises:
obtaining at least one target welding image from each initial welding image using the second detection model, each of the at least one target welding image being obtained by cutting an image corresponding to the welding position of each welded workpiece in each initial welding image;
extracting multi-layer welding feature information from each target welding image using the second detection model, the welding feature information comprising a contour image of the at least one welding spot or a contour image of each workpiece in each target welding image;
obtaining a plurality of refined feature images by performing an up-sampling and a feature fusion on the multi-layer welding feature information using the second detection model, each of the plurality of refined feature images comprising at least one of the contour image of the at least one welding spot, the contour image of each workpiece, and a superposition image of the contour image of the at least one welding spot and the contour image of each workpiece;
obtaining welding information of each welded workpiece by classifying the plurality of refined feature images using the second detection model, the welding information of each welded workpiece comprising the at least one welding spot position.

8. The method according to claim 7, wherein the welding information of each welded workpiece further comprise a contour of the each welded workpiece, a contour of the at least one welding spot, a number of welding spots in each refined feature image, and the method further comprises:
determining whether the welding information is qualified;
determining a welding yield based on the plurality of refined feature images and the qualified welding information;
determining whether the welding yield is greater than or equal to a standard yield; and
determining the stability of the welding equipment based on the welding center position of all welded workpieces, in response that the welding yield is greater than or equal to the standard yield.

9. The method according to claim 3, further comprising:
calculating an average value of the welding center positions of all the welded workpieces in all the plurality of initial welding images;
determining an offset of the welding center position of each welded workpiece based on a preset standard specification position and the average value of the welding center positions of all the welded workpieces; and
adjusting welding parameters based on the offset.

10. The method according to claim 1, wherein the determining of the stability of welding equipment based on the welding center positions of all welded workpieces comprises:
determining a concentration situation of the welding positions of all the welded workpieces based on a welding spot center of each of all the welded workpieces;
determining that the stability of the welding equipment belongs to a first level in response that the concentration situation of the welding positions of all the welded workpieces is relatively concentrated; and
determining that the stability of the welding equipment is belongs to a second level in response that the concentration situation of the welding positions of all the welded workpieces is scattered.

11. The method according to claim 2, wherein determining the stability of the welding equipment based on the welding center positions of all welded workpieces comprises:
comparing the welding spot center average value of each welded workpiece with a preset center threshold;
in response that the welding spot center average value of any one welded workpiece is less than or equal to the preset center threshold, determining that the welding position of the welding equipment is considered relatively stable; or
in response that the welding spot center average value of any one welded workpiece is greater than or equal to the preset center threshold, determining that the welding position of the welding equipment is unstable.

12. The method according to claim 4, wherein determining the stability of the welding equipment based on the welding center positions of all welded workpieces comprises:
determining a total number of welded workpieces whose weld center positions not within the standard weld center position range, based on the welding center position of each welded workpiece;
determining whether the total number of welded workpieces whose weld center positions not within the standard weld center position range meets the preset stable quantity; and
determining that the stability of the welding equipment is low or medium when the total number of welded workpieces whose weld center positions not within the standard weld center position range does not meet the preset stable quantity.

13. The method according to claim 8, wherein determining whether the welding information is qualified comprises:
detecting welding defects according to the welding information; and
determining that the welding information is qualified in response that no welding defect has been detected.

14. The method according to claim 13, wherein the welding defects is selected from missing welding, missing workpiece, missing welding spot, welding spot deviation, welding spot climbing wall, an angel offset of a first workpiece, and a combination thereof.

15. The method according to claim 14, further comprising:
determining that the welding information is unqualified in response that at least one of the welding defects has been detected according to the welding information.

16. A determining device used to determine a stability of a welding equipment, comprising:
a communication device, acquiring a plurality of initial welding images, each of the plurality of initial welding images comprising at least one welded workpiece; and
a processor, coupled to the communication device, being used for:
obtaining at least one welding spot position of each of the at least one welded workpiece by processing the plurality of initial welding images using a detection model;
determining a welding center position of each welded workpiece based on the at least one welding spot position of each welded workpiece output by the detection model; and
determining the stability of the welding equipment based on the welding center positions of all welded workpieces.

17. A welding equipment, wherein the welding equipment receives the stability of the welding equipment determined using the method of claim 1, and adjusts welding parameters of the welding equipment according to the stability of the welding equipment.
